(19) United States
(12) Patent Application Publication
(10) Pub. No.: US 2005/0205200 A1
(43) Pub. Date: Sep. 22, 2005

(54) Process for the production of backing foils provided on one side with a transparent coating and an image

(76) Inventors: Carmen Flosbach, Wuppertal (DE); Peter Frese, Landshut (DE); Phu Qui Nguyen, Moenchengladbach (DE); Martin Wulf, Duesseldorf (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/805,719

(22) Filed: Mar. 22, 2004

(51) Int. Cl. B44C 1/165; B44C 1/00

(52) U.S. Cl. 156/233; 156/230; 156/241; 156/247

(57) ABSTRACT

A process for the production of backing foils provided on one side with an uncured or at most partially cured transparent coating and, on the side of the coating remote from the foil, with an image, the process comprising the successive steps: a) providing a backing foil provided on one side with an uncured or at most partially cured transparent coating of a curable coating composition and b) providing the side of the coating remote from the foil with an image, in particular by printing.

### BACKGROUND OF THE INVENTION

1. Field of the Invention

The invention relates to a process for the production of backing foils provided on one side with a transparent coating and an image, to backing foils equipped in this manner and to the use thereof in processes for providing substrates with images.

2. Description of the Prior Art

A process for transferring graphics into coating surfaces is described on the Internet at the address “www.digital-art-s.de”. In brief, this process involves printing a computer-generated graphic onto a foil and then laying the foil with the side provided with the graphic into an uncured coating layer on a substrate. After sufficient drying, the foil is peeled off and the graphic, which has bonded onto the coating surface, is provided with a protective clear coat layer.

Backing foils coated on one side with an uncured or at most partially cured coating composition are known from WO 03/013739 and WO 03/092912. They can be used for coating of substrates, the coating layer being transferred onto the substrate and cured. As a result, only the cured coating layer remains on the substrate, but not the backing foil, which is removed before or after completion of curing.

### SUMMARY OF THE INVENTION

The invention is a further development of the backing foils known from WO 03/013739 and WO 03/092912, wherein the per se known coated backing foils are provided with an image on their uncured or at most partially cured coating. This image may then be transferred together with the coating onto the surface of a substrate and as a consequence the image and the transparent coating layer covering and protecting the image are applied in a single operation. The transparent coating layer covering the image is cured in the manner which is in principle already known from WO 03/013739 or WO 03/092912.

The invention relates to a process for the production of backing foils provided on one side with an uncured or at most partially cured transparent coating and, on the side of the coating remote from the foil, with an image, said process comprising the successive steps:
a) providing a backing foil provided on one side with an uncured or at most partially cured transparent coating of a curable coating composition and
b) providing the side of the coating remote from the foil with an image, in particular by printing.

### DETAILED DESCRIPTION OF THE EMBODIMENTS

The phrase “transparent coating” used in the description and claims means a coating which is transparent in the cured state. While the coating is uncured or only partially cured, it need not necessarily be transparent. This also applies correspondingly to the coating composition from which the coating is applied. The transparent coating may be colored. Preferably, however, it is colorless and comprises a clear coat layer.

In process step a) of the process according to the invention, a backing foil is provided which is coated on one side with an uncured or at most partially cured transparent coating of a curable coating composition. As mentioned above, backing foils coated in such a manner are known per se, for example, from WO 03/013739 and WO 03/092912.

The backing foils provided in process step a) are produced by being coated on one side with a curable coating composition. The transparent coating so formed is uncured or at most partially cured and is itself a coating composition with regard to the subsequent use thereof.

In a first embodiment, the coating on the backing foil comprises a thermally curable coating composition, in a second embodiment it comprises a coating composition which is curable by means of high-energy radiation and is optionally, additionally thermally curable.

In the case of the first embodiment, the backing foils comprise metal foils, for example, of aluminum, or preferably, foils of any desired, in particular thermoplastic, plastics. The plastics foils are preferably transparent, in particular colorless and transparent. Suitable plastics foil materials are, for example, polyolefins, such as, polyethylene, polypropylene; polyurethane; polyamide and polyesters, such as, polyethylene terephthalate and polybutylene terephthalate. The plastics foils may also consist of polymer blends.

In the case of the second embodiment, the backing foils comprise colored or colorless, in particular transparent foils of any desired, in particular thermoplastic, plastics. In the case of irradiation of the coating with UV radiation in which UV radiation is passed through the backing foil, the foils must transmit UV radiation. Suitable plastics foil materials are, for example, polyolefins, such as, polyethylene, polypropylene; polyurethane; polyamide and polyesters, such as, polyethylene terephthalate and polybutylene terephthalate. The plastics foils may also consist of polymer blends.

The thickness of the foils may, for example, be between 10 and 1000 μm, preferably, between 10 and 500 μm, particularly preferably, between 50 and 150 μm and is determined by practical considerations of processability.

The backing foils selected should preferably be those that are elastic and extensible and cling effectively to the substrate by electrostatic forces.

It may be advantageous to provide a special finish on the side of the backing foil which is to be coated, for example, a release coating, or to use special surface-treated foils, for example, foils surface-modified with silicate layers, in order, on removal of the backing foil, to facilitate detachment from the coating which is subsequently fixed to the substrate together with the image.

The curable coating compositions used to coat the backing foils on one side comprise coating compositions from which coating layers, which are transparent in the cured state, may be applied.

The curable coating compositions themselves are liquid or pasty and may contain water and/or organic solvents or contain neither solvents nor water.

In the case of the first embodiment, coatings of coating compositions curable by input of thermal energy are applied onto one side of the backing foils. Examples of such thermally curable coating compositions are the coating compositions known to the person skilled in the art which contain binders curable by means of cationic and/or free-radical polymerization and/or by means of condensation reactions and/or by means of addition reactions. When selecting the binders, care must be taken to use only those thermally cross-linkable binders that are stable in storage prior to supply of thermal energy.

Thermally cationically curable coating compositions contain one or more cationically polymerizable binders. These may comprise conventional binders known to the person skilled in the art, such as, polyfunctional epoxy oligomers containing more than two epoxy groups per molecule. These comprise, for example, polyalkylene glycol diglycidyl ethers, hydrogenated bisphenol A glycidyl ethers, epoxyurethane resins, glycerol triglycidyl ether, diglycidyl hexahydrophthalate, diglycidyl esters of dimer acids, epoxidized derivatives of (methyl)cyclohexene, such as, for example, 3,4-epoxycyclohexylmethyl(3,4-epoxycyclohexane)carboxylate or epoxidized polybutadiene. The number average molar mass of the polyepoxy compounds is preferably below 10,000. Reactive diluents, such as, cyclohexene oxide, butene oxide, butanediol diglycidyl ether or hexanediol diglycidyl ether, may also be used.

The thermally cationically curable coating compositions contain one or more thermally activatable initiators. Initiators which may be used are, for example, thermolabile onium salts.

Thermally free-radically curable coating compositions contain one or more binders with free-radically polymerizable olefinic double bonds. Suitable binders having free-radically polymerizable olefinic double bonds that may be considered are, for example, all the binders known to the skilled person that can be cross-linked by free-radical polymerization. These binders are prepolymers, such as, polymers and oligomers containing, per molecule, one or more, preferably on average 2 to 20, particularly preferably 3 to 10 free-radically polymerizable olefinic double bonds. The polymerizable double bonds may, for example, be present in the form of (meth)acryloyl, vinyl, allyl, maleate and/or fumarate groups. The free-radically polymerizable double bonds are particularly preferably present in the form of (meth)acryloyl groups.

Both here and below, (meth)acryloyl or (meth)acrylic are respectively intended to mean acryloyl and/or methacryloyl or acrylic and/or methacrylic.

Examples of prepolymers or oligomers include (meth)acryloyl-functional poly(meth)acrylates, polyurethane(meth)acrylates, polyester (meth)acrylates, unsaturated polyesters, polyether(meth)acrylates, silicone(meth)acrylates, epoxy(meth)acrylates, amino(meth)acrylates and melamine(meth)acrylates. The number average molar mass Mn of these compounds may be, for example, 500 to 10,000 g/mole, preferably 500 to 5,000 g/mole. The binders may be used individually or as a mixture. (Meth)acryloyl-functional poly(meth)acrylates and/or polyurethane(meth)acrylates are preferably used.

The prepolymers may be used in combination with reactive diluents, i.e., free-radically polymerizable low molecular weight compounds with a molar mass of below 500 g/mole. The reactive diluents may be mono-, di- or polyunsaturated. Examples of monounsaturated reactive diluents include: (meth)acrylic acid and esters thereof, maleic acid and semi-esters thereof, vinyl acetate, vinyl ethers, substituted vinylureas, styrene, vinyltoluene. Examples of diunsaturated reactive diluents include: di(meth)acrylates, such as, polyethylene glycol di(meth)acrylate, 1,3-butanediol di(meth)acrylate, vinyl(meth)acrylate, allyl(meth)acrylate, divinylbenzene, dipropylene glycol di(meth)acrylate and hexanediol di(meth)acrylate. Examples of polyunsaturated reactive diluents are: glycerol tri(meth)acrylate, trimethylolpropane tri(meth)acrylate and pentaerythritol tri(meth)acrylate, pentaerythritol tetra(meth)acrylate. The reactive diluents may be used alone or in mixture.

The free-radically curable coating compositions may contain thermally activatable free-radical initiators which decompose at different temperatures, depending on the initiator type. Examples of such free-radical initiators include: organic peroxides, organic azo compounds or C—C-cleaving initiators, such as, dialkyl peroxides, peroxycarboxylic acids, peroxydicarbonates, peroxide esters, hydroperoxides, ketone peroxides, azodinitriles or benzopinacole silyl ethers. The free-radical initiators are preferably used in quantities of between 0.1 and 5 wt-%, relative to resin solids content. The thermal initiators may be used individually or in combination.

Thermally curable coating compositions that cure by means of condensation reactions and/or by means of addition reactions contain one or more binders with appropriately cross-linkable functional groups. Suitable binders are those binders or binder systems that are stable in storage prior to supply of thermal energy. One-component binder systems are preferred.

The addition and/or condensation reactions as stated above comprise coatings chemistry cross-linking reactions known to the person skilled in the art, such as, ring-opening addition of an epoxy group onto a carboxyl group forming an ester and a hydroxyl group, the reaction of a hydroxyl group with a blocked isocyanate group forming a urethane group and eliminating the blocking agent, the reaction of a hydroxyl group with an N-methylol group eliminating water, the reaction of a hydroxyl group with an N-methylol ether group eliminating the etherification alcohol, the transesterification reaction of a hydroxyl group with an ester group eliminating the esterification alcohol, the transurethanization reaction of a hydroxyl group with a carbamate group eliminating alcohol, the reaction of a carbamate group with an N-methylol ether group eliminating the etherification alcohol.

Moisture-curing binder components are also possible, for example, compounds with free isocyanate groups, with hydrolyzable alkoxysilane groups or with amino groups blocked as ketimine or as aldimine. In the event that the thermally curable coating compositions contain binders or functional groups that cure by means of atmospheric humidity, certain conditions described below must be maintained during preparation of the coated backing foils in order to avoid premature curing.

The various cross-linking mechanisms described above may be combined at will, provided that they do not mutually interfere. The various cross-linkable functional groups may here be present in the same binder and/or in separate binders. Binders that cross-link without elimination are preferably used. In particular, free-radically polymerizable binder systems are used in combination with thermal initiators. These binder systems may optionally be combined with at least one of the above-stated binder systems which cross-link by means of condensation and/or addition reactions.

In the case of the second embodiment, coatings of coating compositions curable by irradiation with high-energy radiation are applied onto one side of the backing foils. These coating compositions are cationically and/or free-radically curable coating compositions known to the person skilled in the art, wherein free-radically curable coating compositions are preferred.

The coating compositions cationically curable by irradiation with high-energy radiation contain one or more cationically polymerizable binders, for example, the same as those described above in connection with the thermally cationically curable coating compositions.

The cationically curable coating compositions contain one or more photoinitiators. Photoinitiators that may be used are onium salts, such as, diazonium salts and sulfonium salts.

The coating compositions free-radically curable by irradiation with high-energy radiation contain one or more binders with free-radically polymerizable olefinic double bonds. With regard to these binders and further components with free-radically polymerizable olefinic double bonds, the same applies as has already been described above in connection with the thermally free-radically curable coating compositions.

The coating compositions free-radically curable by irradiation with high-energy radiation contain one or more photoinitiators, for example, in quantities of 0.1 to 5 wt-%, preferably of 0.5 to 3 wt-%, relative to the sum of free-radically polymerizable prepolymers, reactive diluents and photoinitiators. Examples of photoinitiators are benzoin and derivatives thereof, acetophenone and derivatives thereof, for example, 2,2-diacetoxyacetophenone, benzophenone and derivatives thereof, thioxanthone and derivatives thereof, anthraquinone, 1-benzoylcyclohexanol, organophosphorus compounds, such as, acylphosphine oxides. The photoinitiators may be used individually or in combination.

It is possible for the coating compositions curable by means of high-energy radiation to contain, in addition to the binder components free-radically and/or cationically polymerizable by means of high-energy radiation, or in addition to the free-radically and/or cationically polymerizable functional groups, further binder components or further functional groups that are chemically cross-linkable by an additional curing mechanism, for example, by condensation and/or addition reactions. Further chemically cross-linking binders that may preferably be used are one-component binder systems, for example, based on OH-functional compounds and aminoplast resins and/or blocked polyisocyanates and those based on carboxy-functional and epoxy-functional compounds. Moisture-curing binder components are also possible, for example, compounds with free isocyanate groups, with hydrolyzable alkoxysilane groups or with amino groups blocked as ketimine or aldimine. In the event that the coating compositions curable by means of high-energy radiation contain binders or functional groups that cure by means of atmospheric humidity, certain conditions described below must be maintained during preparation of the coated backing foils in order to avoid premature curing. The additional functional groups and the free-radically and/or cationically polymerizable functional groups may be present in the same binder and/or in separate binders.

In addition to the resin solids content (total of solids contributed by the binders, crosslinking agents and reactive diluents), the coating compositions may contain constituents which have a favorable influence on quality (image sharpness, color appearance, adhesion between image and coating, durability) and/or acceptance of the image by the coating. Such constituents may, for example, ensure that the image rapidly dries or becomes smudge-resistant, for example, by promoting or ensuring rapid absorption into the coating of volatile substances such as, for example, solvents and/or water from the printing ink used to produce the image. Examples of constituents with the stated action are inorganic fillers, such as talcum, silicon dioxide, aluminum silicate, barium sulfate, calcium carbonate and phyllosilicates (layered silicates). Specifically, it-may be convenient if the inorganic fillers have a particle size which is sufficiently small to ensure that they cause no or substantially no haze in the cured coating. Average particle sizes in the range from 20 to 300 nm are in particular suitable. The inorganic fillers also, preferably, have no intrinsic color. The inorganic fillers are used, for example, in proportions of 1 to 20 wt. %, relative to the resin solids content of the coating compositions and thus also to the resin solids content of the transparent coating on the backing foil.

The coating compositions may contain pigments. If this is the case, the coating compositions have a sufficiently low pigment content for it to be possible to apply them to yield a coating, which is transparent in the cured state. The coating compositions preferably contain no pigments. Coating compositions pigmented with opaque pigments contain color-imparting and/or special effect-imparting pigments. Suitable color-imparting pigments are any conventional coating pigments of an organic or inorganic nature. Examples of inorganic or organic color-imparting pigments are titanium dioxide, micronized titanium dioxide, iron oxide pigments, carbon black, azo pigments, phthalocyanine pigments, quinacridone or pyrrolopyrrole pigments. Examples of special effect-imparting pigments are metal pigments, for example, made from aluminum or copper; interference pigments, such as, metal oxide coated metal pigments, titanium dioxide coated mica.

The coating compositions may also contain transparent pigments and/or soluble dyes.

The coating compositions may also contain conventional coating additives. Examples of conventional coating additives include levelling agents, rheological agents, thickeners, defoamers, wetting agents, anticratering agents, catalysts, antioxidants and light stabilizers based on HALS (hindered amine light stabilizer) products, sterically hindered morpholin-2-one derivatives, in particular, morpholin-2-one derivatives sterically hindered by 3,3,5,5 polysubstitution and/or UV absorbers. The additives are used in conventional amounts known to the person skilled in the art.

The curable coating compositions may be applied onto the side of the backing foil to be coated using conventional methods, for example, by means of brushing, roller coating, flooding, knife coating, spraying or by screen printing. The coating composition may be applied as a melt or in the liquid phase, for example, as a solution. The coating compositions may, for example, be knife coated as a solution. In the subsequent drying process, the solvent is allowed to evaporate, optionally with gentle heating. The coating must in no event be completely crosslinked during the drying process.

In general, the coatings of the curable coating compositions are applied onto the backing foils to dry layer thicknesses of 5 to 100 μm, preferably of 5 to 60 μm.

It may be advantageous to apply the coating with a layer thickness that reduces towards the edges of the backing foil so that, when it is subsequently applied, edge marks on the substrate surface are avoided.

In order to facilitate subsequent removal of the backing foil, it may be advantageous to leave at least one edge zone of the backing foil uncoated.

In particular, if the coating contains no constituents which have a favorable influence on the quality and/or acceptance of the image by the coating, it may be convenient, between performance of process steps a) and b), to apply onto the transparent coating located on the backing foil (first transparent coating) a further transparent coating of a coating composition which contains such constituents. With regard to such constituents in the coating composition for the production of the further transparent coating, for example, with regard to the nature and proportion of such constituents, reference is made to the statements already made above in relation to the production of the coating composition from which the first transparent coating is applied.

The further transparent coating is preferably produced using coating compositions which have the same curing chemistry as those used for the first transparent coating. In particular, it is preferred to use a coating composition which, with the exception of the constituents having a favorable influence on the quality and/or acceptance of the image by the coating, is per se identical, i.e., a coating composition with the same resin solids composition. The further coating is here generally applied in a reduced layer thickness relative to the thickness of the first coating of, for example, only 10 to 50% of the thickness of the first coating.

When a transparent coating is mentioned below, said coating may also mean the above-explained case of two transparent coatings, irrespective of whether in the specific case a corresponding distinction is drawn between the two individual transparent coating layers.

The backing foils provided in process step a) of the process according to the invention are provided in process step b) with an image on the side of their coating remote from the foil. This is in particular achieved by printing. Computer-controlled printing, in particular using the inkjet method, is preferred.

The entire area of the coating is preferably not provided with the image, but it is instead convenient to leave a proportion of, for example, at least 5% of the area of the coating free, for example, a peripheral zone arranged around the outer edges of the image.

The image may comprise single- or multi-colored images, for example, in the form of graphics, patterns, decorations, pictures, logos, words, photographs and the like. It is essential that the image applied onto the coating is a mirror image of the image which is subsequently transferred together with the coating from the backing foil onto the substrate surface.

Application of the image onto the coating according to process step b) may, depending on the nature of the image, be carried out in a long or short run manufacturing process or also on an individual, for example, custom, basis.

Process step b) may, however, also proceed completely separately from process step a), for example, on a private or commercial user's premises and in particular by printing onto the coating located on the backing foil by means of a PC and printer, in particular an inkjet printer.

Once the image has been applied onto the coating, the finished backing foil may be used immediately in order to provide a substrate surface with an image covered by a transparent coating layer or the finished backing foil provided with a coating and image may first be stored.

In particular, if the backing foil provided with a coating and an image is not immediately used, it may be advantageous to provide it with a temporary protective foil.

The protective foil may here be present only on the coated side of the backing foil, but it may also be applied onto both sides and completely enclose the entire backing foil. The latter possibility would in particular be advisable in the event of presence of the above-described moisture-curing binder or functional groups in order to exclude atmospheric humidity. In order to facilitate detachment of the protective foil, it too may be provided with non-stick properties, as described above.

The backing foils provided with a coating and an image, optionally provided with protective foil or protective envelope, may be prefabricated and stored in the most varied shapes and sizes, for example, in sizes of 5 cm² to 5 m². The backing foils may also be stored as a reel of continuous foil.

The backing foils provided with a coating and an image may be cut into pieces of the correct size adapted to the coating task before use or they are already correctly dimensioned, for example, in the form of a set of correctly dimensioned backing foils provided with a coating and an image.

The invention relates not only to the coated backing foils (provided with a transparent coating or with a first and a further coating, each of which is transparent) provided with an image and to the process for the production thereof, but also to the use thereof in a process for providing substrate surfaces with images covered by a transparent coating layer. The transparent coating layer may here be obtained from the single transparent coating or from the combination of two transparent coatings on the backing foil.

The process comprises a process for the provision of substrate surfaces with images covered by a transparent coating layer, comprising the successive steps:
a′) providing a substrate to be provided with an image covered with a transparent coating layer and of a backing foil provided on one side with a first uncured or at most partially cured transparent coating, optionally, a further transparent coating with an image on the side of the transparent coating remote from the foil,
b′) applying the backing foil with its coated side provided with the image onto the substrate,
c′) curing of at least the first transparent coating and
d′) removing the backing foil from the transparent coating which, together with the image, remains on the substrate, wherein curing according to process step c′) proceeds before and/or after removal of the backing foil.

The substrates provided in process step a′) may consist of one or more different materials, for example, metal, plastics, composite materials, wood, glass or ceramics and may be uncoated or provided with one or more prior coating layers. Examples of substrates are motor vehicles, bodywork parts, cladding parts, window frames, window glazing, domestic appliances, sports equipment or signs.

In addition to the provision of a substrate, process step a′) involves the provision of a backing foil provided on one side with a transparent coating and, on the side of the coating remote from the foil, with an image which may be produced as described above. The transparent coating may comprise a single uncured or at most partially cured transparent coating or a first uncured or at most partially cured transparent coating and a further transparent coating. The further transparent coating may here be a physically drying coating, a cured coating or preferably an uncured or at most partially cured coating. In particular, it is preferred if the resin solids content of the first coating and that of the further coating do not differ and thus exhibit an identical curing chemistry.

In process step b′), the backing foils, which have been coated and provided with an image, are applied onto a substrate. The coated backing foils are applied by lamination, preferably under pressure and optionally with heating and the coating is thus attached to the substrate. This may in particular be achieved by using devices known from laminate production which have optionally been suitably modified, for example, with a heatable roll, for example, a rubber roll.

Once the coated side of the coated backing foil has been applied onto the substrate, the transparent coating is cured in step c′) by supply of thermal energy to the coating (first embodiment) or the coating is irradiated with high-energy radiation (second embodiment). The same applies in the case that the transparent coating is composed of two transparent coatings and the further transparent coating is also curable.

In the first embodiment, the supply of thermal energy may proceed prior to removal of the backing foil, for example, through the backing foil, and/or the transparent coating is exposed to thermal energy after removal of the backing foil. When using systems comprising binders cross-linkable by means of condensation reactions, thermal energy is advantageously supplied only once the backing foil has been removed since the elimination products arising during the cross-linking reaction may otherwise be disruptive.

Thermal energy (heat) may be supplied to the transparent coating in various ways, in each case providing a temperature in the coating for a period of time sufficient to cure (crosslink) the coating. The person skilled in the art knows or knows how to determine and how to provide the temperature/time conditions required for cross-linking the various thermally curable coating systems. Supply of thermal energy according to process step c′) may proceed using a single method or a combination of two or more conventional methods, for example, by radiant heating by means of infrared and/or near infrared irradiation and/or by convection, for example, by means of hot air and/or by induction heating (in the case of metallic substrates) and/or by contact heating, for example, using a heatable heat-transfer means, such as, a heatable roller or plate which is applied or laid directly on the uncoated outer side of the coated backing foil.

When supplying thermal energy prior to the removal of the backing foil, the foil is removed in process step d′) after the energy has been supplied. To this end, the transparent coating is advantageously first allowed to cool before the foil is removed.

One particular form of the first embodiment consists in effecting a partial cure of the transparent coating by initially supplying thermal energy prior to the removal of the backing foil and, once the foil has been removed, effecting final curing in a second energy supply step. In other words, the dose of thermal energy required for complete cure is supplied in at least two separate steps.

In the second embodiment, irradiation of the transparent coating with high-energy radiation may proceed through the backing foil and/or the transparent coating is irradiated after removal of the backing foil. UV radiation or electron beam radiation may be used as high-energy radiation. UV radiation is preferred. Irradiation may proceed continuously or discontinuously (in cycles).

The UV irradiation may be carried out, for example, in a belt unit fitted with one or more UV radiation emitters or with one or more UV radiation emitters positioned in front of the object to be irradiated, or the area to be irradiated, or the substrate to be irradiated and/or the UV radiation emitter(s) is(are) moved relative to one another during irradiation. For example, the substrate to be irradiated may be moved through an irradiation tunnel fitted with one or more UV radiation emitters, and/or a robot equipped with one or more UV radiation emitters may guide the UV radiation emitter(s) over the substrate surface. Particularly in workshops it is also possible to use UV hand lamps.

In principle, the duration of UV irradiation, distance from the object and/or radiation output of the UV radiation emitter may be varied during UV irradiation. The preferred source of UV radiation comprises UV radiation sources emitting in the wavelength range from 180 to 420 nm, in particular, from 200 to 400 nm. Examples of such continuously operating UV radiation sources are optionally doped high, medium and low pressure mercury vapour emitters and gas discharge tubes, such as, for example, low pressure xenon lamps. However, it is also possible to use discontinuous UV radiation sources. These are preferably so-called high-energy flash devices (UV flash lamps for short). The UV flash lamps may contain a plurality of flash tubes, for example, quartz tubes filled with inert gas, such as, xenon. The UV flash lamps have an illuminance of, for example, at least 10 megalux, preferably, from 10 to 80 megalux per flash discharge. The energy per flash discharge may be, for example, 1 to 10 kjoule.

The irradiation time with UV radiation when UV flash lamps are used as the UV radiation source may be, for example, in the range from 1 millisecond to 400 seconds, preferably, from 4 to 160 seconds, depending on the number of flash discharges selected. The flashes may be triggered, for example, about every 4 seconds. Curing may occur, for example, by means of 1 to 40 successive flash discharges.

If continuous UV radiation sources are used, the irradiation time may be, for example, in the range from a few seconds to about 5 minutes, preferably, less than 5 minutes.

The distance between the UV radiation sources and the substrate surface to be irradiated may be, for example, 5 to 60 cm.

Irradiation with UV radiation may proceed in one or more successive irradiation steps. In other words, the energy to be applied by UV irradiation may be supplied completely in a single irradiation step or in portions in two or more irradiation steps.

When the transparent coating is irradiated by means of UV radiation, in particular with UV flash lamps, temperatures may be generated on or in the coating that are such that, in the event that the transparent coating cures by an additional cross-linking mechanism as well as UV-induced polymerization, they give rise to at least partial curing by means of this additional cross-linking mechanism.

In order to cure the transparent coatings by means of the additional cross-linking mechanism, the coatings may, however, also be exposed to relatively high temperatures of, for example, 60 to 140° C. to cure completely. Complete curing may take place by conventional methods, for example, in an oven or in a conveyor unit, for example, with hot air and/or infrared radiation. Depending upon the curing temperature, curing times of 1 to 60 minutes are possible. The additional thermal curing can be performed prior to, during and/or after irradiation with high-energy radiation. An appropriately heat-resistant foil material must be selected depending upon the curing temperatures required for the additional thermal curing.

For transparent coatings that are curable by free-radical and/or cationic polymerization but not enhanced by an additional crosslinking mechanism, it may be expedient to supply additional thermal energy to support the curing.

In the preferred case of UV irradiation through the backing foil, the foil is removed after irradiation. In the case of additional thermal curing, it is expedient, if the transparent coating is first allowed to cool before the foil is removed.

One particular form of the second embodiment consists in partial curing of the transparent coating by irradiation (by means of irradiation induced free-radical and/or cationic polymerization) through the backing foil and performing final curing in a second irradiation step after removal of the foil. In other words, the radiation dose required for complete cure (by means of irradiation induced free-radical and/or cationic polymerization) is supplied in at least two separate irradiation steps.

In the event that the transparent coating contains binders that cure by an additional cross-linking mechanism, it is possible, for example, in a first step completely or partially to cure the transparent coating with regard to the free-radical and/or cationic polymerization by means of irradiation and, after removal of the foil, firstly to perform any outstanding final curing with regard to free-radical and/or cationic polymerization by means of irradiation and then to supply thermal energy for further curing by means of the additional cross-linking mechanism. It is, however, also possible to perform thermal curing before radiation curing.

Once the substrate surface has been provided with the image(s) and the transparent coating layer covering it/them, further steps may be performed. For example, blending in by polishing may be performed and/or one or more further clear coat layers may be applied.

The backing foils provided with an image and a transparent coating are suitable for providing substrate surfaces with an image and a protective transparent coating layer in a single operation. This may be used in industrial applications, for example, as part of an industrial or vehicle coating operation. Use in workshops, such as, for example, automotive repair shops or body shops, or in do-it-yourself applications is also possible.

The present invention is further defined in the following Examples. It should be understood that these Examples are given by way of illustration only. From the above discussion and these Examples, one skilled in the art can ascertain the essential characteristics of this invention, and without departing from the spirit and scope thereof, can make various changes and modifications of the invention to adapt it to various uses and conditions. As a result, the present invention is not limited by the illustrative examples set forth herein below, but rather is defined by the claims contained herein below.

### EXAMPLES

### Example 1

A polyurethane resin curable by free-radical polymerization was first produced as follows:

587 pbw (parts by weight) of isophorone diisocyanate were combined with 0.6 pbw of methylhydroquinone and 0.2 pbw of dibutyltin dilaurate and heated to 70° C. 165 pbw of neopentyl glycol were then added in such a manner that the reaction temperature did not rise above 90° C. Once addition was complete, the temperature was raised to 100° C. and maintained until an NCO value of 11.8 had been obtained. Once the NCO value had been obtained, 244 pbw of hydroxyethyl acrylate were added dropwise in such a manner that the temperature did not exceed 110° C. The reaction mixture was maintained at a maximum of 110° C. until an NCO-value of <0.1 was obtained. After cooling, the mixture was diluted with butyl acetate to a solids content of 75 wt. %.

A thermally curable clear coat was then produced from the following constituents:
80.8 pbw of the acryloyl-functional polyurethane resin produced above,
1.3 pbw of a commercially available thermolabile peroxide free-radical initiator (Trigonox® 21 from Akzo),
0.1 pbw of a conventional commercial levelling agent (Ebecryl® 350/UCB)
0.8 pbw of a conventional commercial UV absorber (Tinuvin® 384/CIBA)
0.8 pbw of a conventional commercial light stabilizer (HALS based; Tinuvin® 292/CIBA)
16.2 pbw of butyl acetate
5.0 pbw of Optigel® WM (layered silicate, Südchemie).

The resultant clear coat was then applied onto a backing foil. To this end, the clear coat was blade coated to a dry film thickness of 40 μm onto one side of a 20 μm thick polyester foil (DIN A4 format). The applied clear coat layer was dried for 10 minutes at 60° C. to evaporate the solvent.

The foil coated in said manner was printed on the coated side with a mirror image of a multi-color graphic using a PC-controlled inkjet printer (Epson Stylus 800, foil printing mode).

The foil produced above was laid with its coated and printed side on a metal test panel coated with a typical automotive multi-layer coating comprising electrodeposited primer, filler coat, base coat and clear coat.

The coating layer was then heated through the backing foil with an IR radiation emitter to approximately 80° C. and laminated without bubbles under gentle pressure. The still warm and softened coating material was then irradiated through the backing foil for 20 minutes and cured by means of a conventional commercial infrared radiation emitter (emission spectrum maximum: 2,4 μm; 20 kW/m²) at a distance of 40 cm. The foil was then peeled off.

The metal test panel was provided with the graphic, which was now the right way round, and a cured clear coat layer covering said graphic. When viewed by an observer, the image appears as intended, namely, as the mirror image of the mirror image that had been printed on the coating on the backing foil.

### Example 2

A clear coat was produced as in Example 1, except that a conventional commercial photoinitiator (Irgacure® 184, CIBA) was used instead of the peroxide free-radical initiator.

Using this clear coat, a coated backing foil was then produced and used in a similar manner as in Example 1. The only difference was that in the present case curing did not proceed by infrared irradiation of the still warm and softened coating material, but instead by irradiation through the foil with 5 flashes by means of a UV flash lamp (3000 Ws) at a distance of 20 cm. The flashes were triggered every 4 seconds. Thereafter, the backing foil was peeled off and the coating layer remaining on the panel was post-cured by means of additional 10 flashes.

A metal test panel provided with the graphic the right way round and a cured clear coat layer covering said graphic was obtained. As in Example 1, when viewed by an observer, the image appears as intended, namely, as the mirror image of the mirror image that had been printed on the coating on the backing foil.

1. A process for the production of a backing foil consisting of a foil one side having an uncured or at most partially cured transparent coating and, on the side of the coating remote from the foil, having an image thereon, said process comprising the successive steps:
a) providing a backing foil consisting of a foil coated on one side with an uncured or at most partially cured transparent coating of a curable coating composition. and
b) providing the side of the coating remote from the foil with an image.

2. The process of claim 1, wherein the side of the coating remote from the foil is provided with the image in process step b) by printing.

3. The process of claim 2, wherein printing proceeds by inkjet printing.

4. The process of claim 1, wherein the transparent coating comprises a coating selected from the group consisting of thermally curable coatings, coatings curable by means of high-energy radiation and coatings which are curable by means of high-energy radiation and additionally by thermal means.

5. The process of claim 1, wherein the transparent coating contains 1 to 20%, relative to the resin solids content, of an inorganic filler.

6. The process of claim 1, wherein, between the performance of process steps a) and b), a further transparent coating is applied of a coating composition which contains 1 to 20 wt. %, relative to the resin solids content, of an inorganic filler.

7. The process of claim 6, wherein the coating composition used to apply the further transparent coating has the same resin solids composition as the transparent coating on the backing foil provided in process step a).

8. Backing foil consisting of a foil coated with an uncured or at most partially cured transparent coating and provided with an image using the process of claim 1.

9. A process for providing substrate surfaces with images covered by a transparent coating layer, comprising the successive steps:
a′) providing a substrate to be provided with an image covered with a transparent coating layer and of a backing foil consisting of a foil one side having a first uncured or at most partially cured transparent coating, optionally, a further transparent coating and, on the side of the transparent coating remote from the foil, having an image thereon,
b′) applying the backing foil with its coated side provided with the image onto the substrate,
c′) curing of at least the first transparent coating and
d′) removing the foil from the transparent coating which, together with the image, remains on the substrate, wherein curing according to process step c′) proceeds before and/or after removal of the foil.

10. The process of claim 9, wherein the first transparent coating is thermally curable and curing proceeds in step c′) by supply of thermal energy by means of a method selected from the group consisting of radiant heating, convection, induction heating, contact heating and any desired combination thereof.

11. The process of claim 9, wherein the first transparent coating is curable by means of high-energy radiation and the curing in step c′) proceeds by irradiation with high-energy radiation selected from the group consisting of electron beam radiation and UV radiation.

12. The process of claim 9, wherein the curable coating composition is a coating composition curable thermally and by means of high-energy radiation and the curing in step c′) proceeds by supply of thermal energy by means of a method selected from the group consisting of radiant heating, convection, induction heating, contact heating and any combination thereof and by irradiation with high-energy radiation selected from the group consisting of electron beam radiation and UV radiation.
